(19) United States
(12) Patent Application Publication
(10) Pub. No.: US 2024/0071259 A1
(43) Pub. Date: Feb. 29, 2024

(54) LABEL ASSEMBLY HAVING CUT WITH CURVED PORTIONS AND LABEL SHEET INCLUDING SAME

(71) Applicant: SATO HOLDINGS KABUSHIKI KAISHA, Tokyo (JP)

(72) Inventor: Christopher JONES, Charlotte, NC (US)

(73) Assignee: SATO HOLDINGS KABUSHIKI KAISHA, Tokyo (JP)

(21) Appl. No.: 18/239,388

(22) Filed: Aug. 29, 2023

Related U.S. Application Data
(60) Provisional application No. 63/402,370, filed on Aug. 30, 2022.

(51) Int. Cl. G09F 3/02; G09F 3/10

(52) U.S. Cl. CPC G09F 3/02; G09F 3/10; G09F 2003/0201; G09F 2003/0222; G09F 2003/0226; G09F 2003/0267

(57) ABSTRACT

A label sheet includes a plurality of label assemblies. Each label assembly includes a label and a liner. The label includes a label first portion having an adhesive surface, and a label second portion having an adhesive surface. The liner includes a liner first portion coupled to the label first portion, the liner first portion configured to be separable from the label first portion, and a liner second portion coupled to the label second portion. A cut is formed in the liner and positioned between the liner first portion and the liner second portion. The cut includes a first curved portion positioned at a first edge of the liner and a second curved portion positioned at a second edge of the liner.

### CROSS-REFERENCE TO RELATED APPLICATION

The present application claims the benefit of U.S. Provisional Application No. 63/402,370, filed on Aug. 30, 2022, the entire contents of which are hereby incorporated by reference.

### BACKGROUND

The present application relates generally to the field of label assemblies for use in communicating information. More specifically, the present application relates to label sheets including label assemblies, label assemblies, methods of manufacturing label sheets including label assemblies, and methods of manufacturing label assemblies.

Label assemblies are used to attach labels to structures such as shelves to communicate information.

### SUMMARY

Cuts in known label assemblies have perforations and ties between the perforations. The ties provide structural support to the label assemblies and inhibit undesired folding along the cuts. However, the ties make the label assemblies susceptible to generating liner remnants when a first portion of a liner is removed from a label of the label assembly.

In some embodiments, a label sheet includes a plurality of label assemblies. Each label assembly includes a label and a liner. The label includes a label first portion having an adhesive surface, and a label second portion having an adhesive surface. The liner includes a liner first portion coupled to the label first portion, the liner first portion configured to be separable from the label first portion, and a liner second portion coupled to the label second portion. A cut is formed in the liner and positioned between the liner first portion and the liner second portion. The cut includes a first curved portion positioned at a first edge of the liner and a second curved portion positioned at a second edge of the liner.

In some embodiments, a label assembly includes a label and a liner. The label includes a label first portion having an adhesive surface, and a label second portion having an adhesive surface. The liner includes a liner first portion coupled to the label first portion, the liner first portion configured to be separable from the label first portion, and a liner second portion coupled to the label second portion. A cut is formed in the liner and positioned between the liner first portion and the liner second portion. The cut includes a first curved portion positioned at a first edge of the liner and a second curved portion positioned at a second edge of the liner.

In some embodiments, a method of manufacturing a label sheet includes providing a plurality of label assemblies. Each label assembly includes a label and a liner. The label includes a label first portion having an adhesive surface, and a label second portion having an adhesive surface. The liner includes a liner first portion coupled to the label first portion, and a liner second portion coupled to the label second portion. The method also includes forming a cut in each liner. The cut is positioned between the liner first portion and the liner second portion. The cut includes a first curved portion positioned at a first edge of the liner and a second curved portion positioned at a second edge of the liner. The liner first portion is configured to be separable from the label first portion.

In some embodiments, a method of manufacturing a label assembly includes providing a liner and a label. The label includes a label first portion having an adhesive surface, and a label second portion having an adhesive surface. The liner comprises a liner first portion coupled to the label first portion, and a liner second portion coupled to the label second portion. The method also includes forming a cut in the liner. The cut is positioned between the liner first portion and the liner second portion. The cut includes a first curved portion positioned at a first edge of the liner and a second curved portion positioned at a second edge of the liner. The liner first portion is configured to be separable from the label first portion.

### BRIEF DESCRIPTION OF THE DRAWINGS

A clear conception of the advantages and features constituting the present disclosure, and of the construction and operation of typical mechanisms provided with the present disclosure, will become more readily apparent by referring to the exemplary, and therefore non-limiting, embodiments illustrated in the drawings accompanying and forming a part of this specification, wherein like reference numerals designate the same elements in the several views, and in which:

FIG. 1 is a top view of a known label sheet having a plurality of known label assemblies.

FIG. 2A is a top view of one of the plurality of known label assemblies of FIG. 1;

FIG. 2B is a top view of the known label assembly of FIG. 2A showing a liner first portion of a liner removed and a plurality of liner fragments.

FIG. 3 is a top view of a label sheet having a plurality of label assemblies, according to an embodiment.

FIG. 4A is a top view of one of the plurality of label assemblies according to the embodiment of FIG. 3; FIG. 4B is a top view of the label assembly of FIG. 3 showing a liner first portion of a liner removed.

FIG. 5 is a side view of the label assembly according to the embodiment of FIG. 4A, showing an adhesive surface of each of the label first portion and the label second portion.

FIG. 6 is a top view of the label assembly according to the embodiment of FIG. 4B, showing a first curved portion of a cut having a first dimension and a second dimension.

The foregoing and other features of the present disclosure will become apparent from the following description and appended claims, taken in conjunction with the accompanying drawings. Understanding that these drawings depict only several embodiments in accordance with the disclosure and are therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

To improve the application of label assemblies to structures such as shelves to communicate information, it may be desirable to use a label assembly with no or minimal ties to reduce the possibility of generating liner remnants when a liner first portion is removed from the label assembly. Liner remnants may obstruct the ability to view printed material on the label assembly and may interfere with the application of the label assembly to the structure. However, when a label assembly does not have the ties, during the manufacturing process a label sheet containing the label assembly is more likely to fold along a cut that is straight and formed in the label assembly, such folding being undesirable.

Various embodiments of the label assemblies and label sheets containing label assemblies described herein may provide one or more advantages, including, for example: (1) reducing or eliminating the possibility of generating liner remnants when a liner first portion is removed from the label assembly; and (2) reducing the likelihood of a label sheet containing the label assembly folding along a cut formed in the label assembly during the manufacturing process by providing increased structural integrity in parts of a liner of a label assembly.

### Overview of Known Label Sheets Containing Known Label Assemblies and Known Label Assemblies

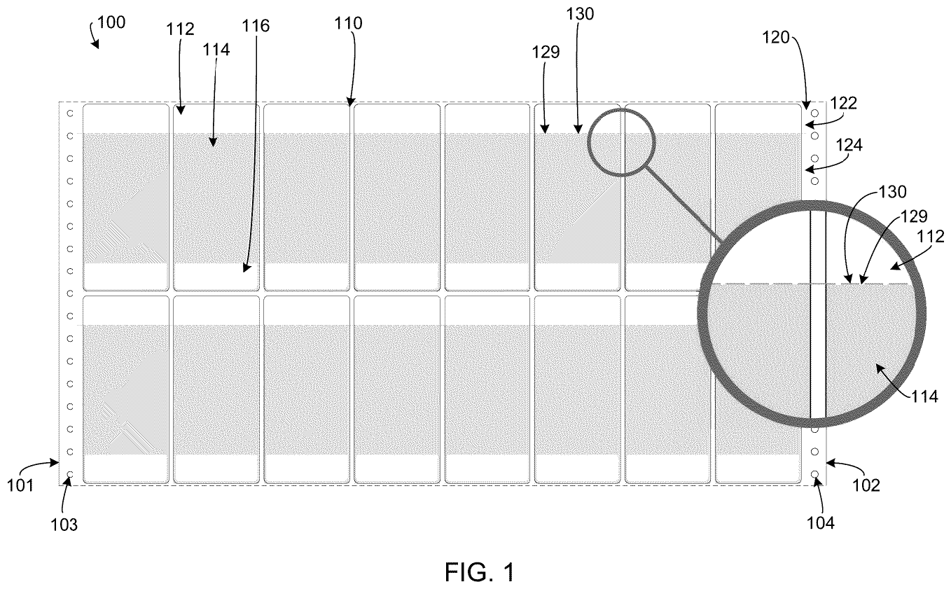

FIG. 1 depicts a known label sheet 100 containing a plurality of known label assemblies 105 (e.g., shelf talkers). Each label assembly 105 includes a label 110 and a liner 120. The label 110 includes a label first portion 112 and a label second portion 114. The label 110 includes a label first portion 112 having an adhesive surface, and a label second portion 114 having an adhesive surface. The liner 120 includes a liner first portion 122 coupled to the label first portion 112, the liner first portion 122 configured to be separable from the label first portion 112, and a liner second portion 124 coupled to the label second portion 114. A cut 130 is formed in the liner 120 and positioned between the liner first portion 122 and the liner second portion 124.

The label sheet 100 includes a plurality of label assemblies 105 (e.g., shelf talkers, etc.). As shown in FIG. 1, the label sheet 100 has a shape that is a rectangle. As shown in FIG. 1, the label sheet 100 includes a first row of pin-feeding holes 103 at a first edge 101 of the label sheet 100 and a second row of pin-feeding holes 104 at a second edge 102 of the label sheet 100.

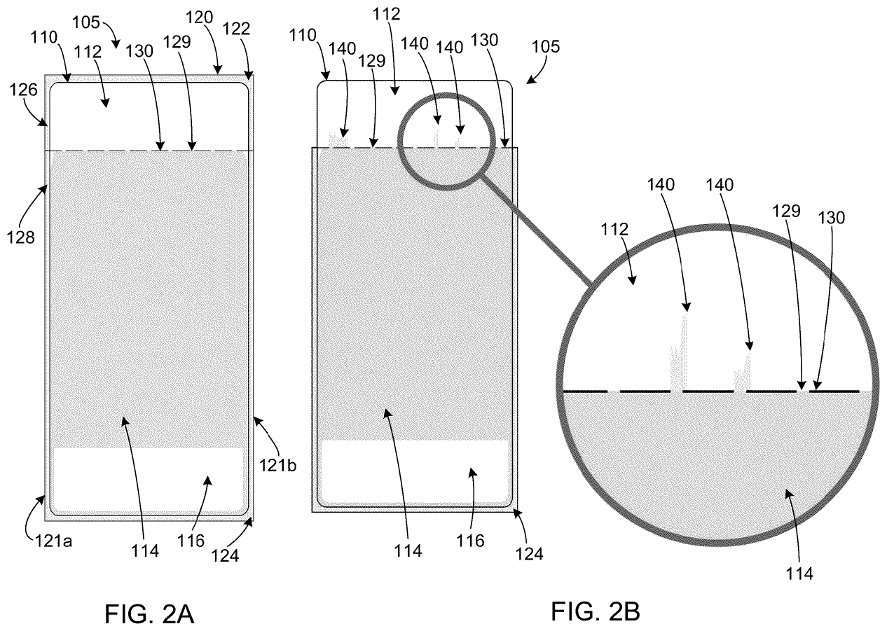

Each of the plurality of label assemblies 105 includes a label 110 as shown in FIGS. 1-2B.

As shown in FIGS. 2A and 2B, the label 110 has a label first portion 112 and a label second portion 114. The label first portion 112 has an adhesive surface and the label second portion 114 has an adhesive surface. The label first portion 112 has a second surface that is opposite the adhesive surface of the label first portion 112. The label second portion 114 has a second surface that is opposite the adhesive surface of the label second portion 114.

At least one of the second surface of the label first portion 112 and the second surface of the label second portion 114 may contain printed material. As shown in FIGS. 1-2B, the second surface of the label second portion 114 may have a box 116.

The label assembly 105 includes a liner 120 as shown in FIGS. 1-2B.

As shown in FIGS. 2A and 2B, the liner 120 has a liner first portion 122 that is coupled to the label first portion 112. The liner first portion 122 is configured to be separable from the label first portion 112. The liner 120 has a liner second portion 124 that is coupled to the label second portion 114.

As shown in FIG. 2A, a part 126 of the liner first portion 122 is located outward of the label 110 in the top view of the label sheet 100. As shown in FIGS. 2A and 2B, a part 128 of the liner second portion 124 is located outward of the label 110 in the top view of the label sheet 100. In the label sheet 100, the part 126 of the liner first portion 122 and the part 128 of the liner second portion 124 of multiple label assemblies 105 together form an area of the liners 120 that is located outward of any label 110.

The label assembly 105 includes a cut 130 formed in the liner 120. As shown in FIGS. 1-2B, the cut 130 is straight. The cut 130 extends from a first edge 121a of the liner 120 to a second edge 121b of the liner 120.

The cut 130 is not continuous, as the cut 130 is perforated such that the liner 120 has a plurality of ties 129 that interrupt the cut 130. The cut 130 is also straight in the part 126 of the liner first portion 122 and the part 128 of the liner second portion 124, which are located outward of the label 110, and are positioned at least partially in between a first label 110 of a first one of the plurality of label assemblies 105 and a second label 110 of a second one of the plurality of label assemblies 105 of the label sheet 100.

The liner first portion 122 is configured to be separable from the label first portion 112. When the liner first portion 122 is separated from the label first portion 112, liner remnants 140 may be formed. The liner remnants 140 are portions of the liner first portion 122 that remain coupled to the label first portion 112 during separation of the liner first portion 122. The liner remnants 140 are connected to the liner second portion 124 by the ties 129.

### Label Sheets Containing Label Assemblies and Label Assemblies According to Embodiments

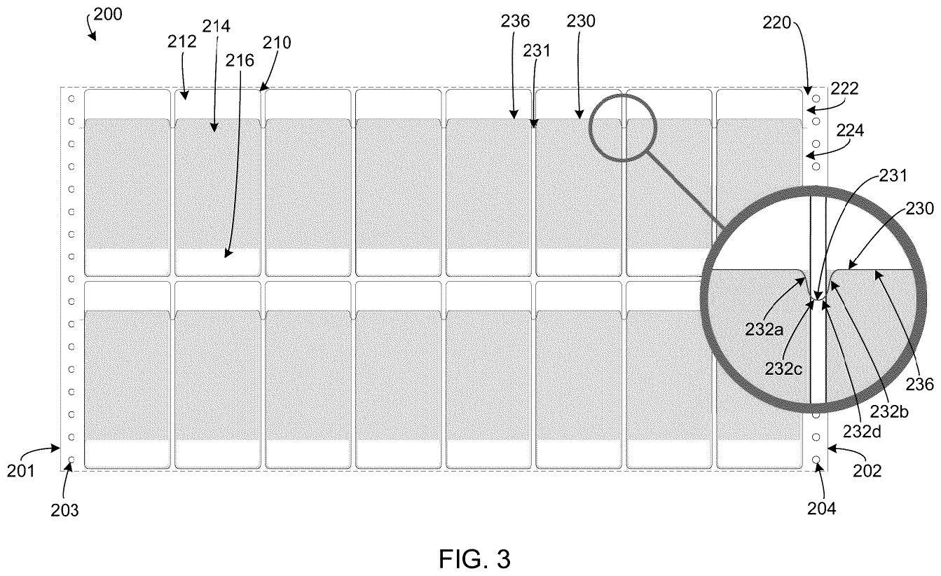

FIG. 3 depicts a label sheet 200 including a plurality of label assemblies 205 according to an embodiment of the present disclosure. Each label assembly 205 includes a label 210 and a liner 220. The label 210 includes a label first portion 212 having an adhesive surface 213a, and a label second portion 214 having an adhesive surface 215a. The liner 220 includes a liner first portion 222 coupled to the label first portion 212, the liner first portion 222 configured to be separable from the label first portion 212, and a liner second portion 224 coupled to the label second portion 214. A cut 230 is formed in the liner 220 and positioned between the liner first portion 222 and the liner second portion 224. The cut 230 includes a first curved portion 232a positioned at a first edge 221a of the liner 220 and a second curved portion 232b positioned at a second edge 221b of the liner 220.

The label sheet 200 (e.g., paper, page, etc.) includes a plurality of label assemblies 205 (e.g., shelf talkers, etc.). As shown in FIG. 3, the label sheet 200 has a shape that is a rectangle. In other embodiments, the label sheet 200 may have a shape that is a square, parallelogram, or other geometric shape.

The label sheet 200 may be made of plastic, paper, or other suitable materials.

As shown in FIG. 3, the label sheet 200 includes a first row of pin-feeding holes 203 at a first edge 201 of the label sheet 200 and a second row of pin-feeding holes 204 at a second edge 202 of the label sheet 200. In other embodiments, the label sheet 200 may not include the first row of pin-feeding holes 203 and the second row of pin-feeding holes 204. As shown in FIG. 3, the first edge 201 of the label sheet 200 is parallel to the second edge 202 of the label sheet 200. As shown in FIG. 3, the first edge 201 and the second edge 202 of the label sheet 200 are the edges of the label sheet 200 having a shorter dimension of the label sheet 200. In other embodiments, the first edge 201 and the second edge 202 of the label sheet 200 are the edges of the label sheet 200 having a longer dimension of the label sheet 200.

As shown in FIG. 3, the plurality of label assemblies 205 is arranged in two rows on the label sheet 200. In other embodiments, the plurality of label assemblies 205 may be arranged in one, three, or more rows on the label sheet 200. As shown in FIG. 3, the plurality of label assemblies 205 is arranged in eight columns on the label sheet 200. In other embodiments, the plurality of label assemblies 205 may be arranged in one, two, three, four, five, six, seven, or more columns on the label sheet 200. As shown in FIG. 3, the plurality of label assemblies 205 is arranged on the label sheet 200 such that a longer dimension of each of the plurality of label assemblies 205 is perpendicular to a longer dimension of the label sheet 200. In other embodiments, the plurality of label assemblies 205 may be arranged on the label sheet 200 such that the shorter dimension of each of the plurality of label assemblies 205 is perpendicular to the longer dimension of the label sheet 200. In other embodiments, some of the plurality of label assemblies 205 may be arranged on the label sheet 200 such that the longer dimension of each of the some of the plurality of label assemblies 205 is perpendicular to the longer dimension of the label sheet 200 and others of the plurality of label assemblies 205 may be arranged on the label sheet 200 such that the shorter dimension of each of the others of the plurality of label assemblies 205 is perpendicular to the longer dimension of the label sheet 200.

Each of the plurality of label assemblies 205 includes a label 210 (e.g., tag, etc.). As shown in FIGS. 3, 4A, 4B, and 6, the label 210 has a shape that is a rounded rectangle. In other embodiments, the label 210 may have a shape that is a rounded square, a rounded polygon, a rectangle, a square, a rounded polygon, a polygon, or other geometric shape.

The label 210 may be made of plastic, paper, or other suitable materials.

As shown in FIG. 5, the label 210 has a label first portion 212 and a label second portion 214. As shown in FIGS. 3, 4A, 4B, and 6, the label second portion 214 is larger than the label first portion 212. In other embodiments, the label second portion 214 may be smaller than the label first portion 212. In other embodiments, the label second portion 214 and the label first portion 212 may have the same size.

As shown in FIG. 5, the label first portion 212 has an adhesive surface 213a and the label second portion 214 has an adhesive surface 215a. The adhesive surface 213a of the label first portion 212 and the adhesive surface 215a of the label second portion 214 have a glue or other suitable adhesive material.

As shown in FIG. 5, the label first portion 212 has a second surface 213b (e.g., front, display, etc.) that is opposite the adhesive surface 213a of the label first portion 212. As shown in FIG. 5, the label second portion 214 has a second surface 215b (e.g., front, display, etc.) that is opposite the adhesive surface 215a of the label second portion 214.

In some embodiments, at least one of the second surface 213b of the label first portion 212 and the second surface 215b of the label second portion 214 contains printed material. For example, the printed material may be text, letters, numbers, images, symbols, colors, shapes, or other suitable printed material. In some embodiments, the printed material is laser-printed material.

As shown in FIGS. 3, 4A, 4B, and 6, the second surface 215b of the label second portion 214 may have a box 216. The box 216 is a portion of the second surface 215b of the label second portion 214 that has a different color than a remainder of the second surface 215b of the label second portion 214. For example, the box 216 may be used to draw attention to printed material contained on the box 216. In some embodiments, the box 216 may have a color that is white. In other embodiments, the box 216 may have different color or may have multiple colors. As shown FIGS. 3, 4A, 4B, and 6, the box 216 has a shape that is a rectangle with two rounded corners. In other embodiments, the box 216 may have a shape that is a rectangle, a polygon, a circle, an oval, a rounded rectangle, a rounded polygon, or other geometric shape. As shown FIGS. 3, 4A, 4B, and 6, the box 216 is positioned closer to an edge of the second surface 215b of the label second portion 214. In other embodiments, the box 216 may be positioned at a different location of the second surface 215b of the label second portion 214. As shown FIGS. 3, 4A, 4B, and 6, the second surface 215b of the label second portion 214 has one box 216. In other embodiments, the second surface 215b of the label second portion 214 may have two, three, four, or more boxes 216.

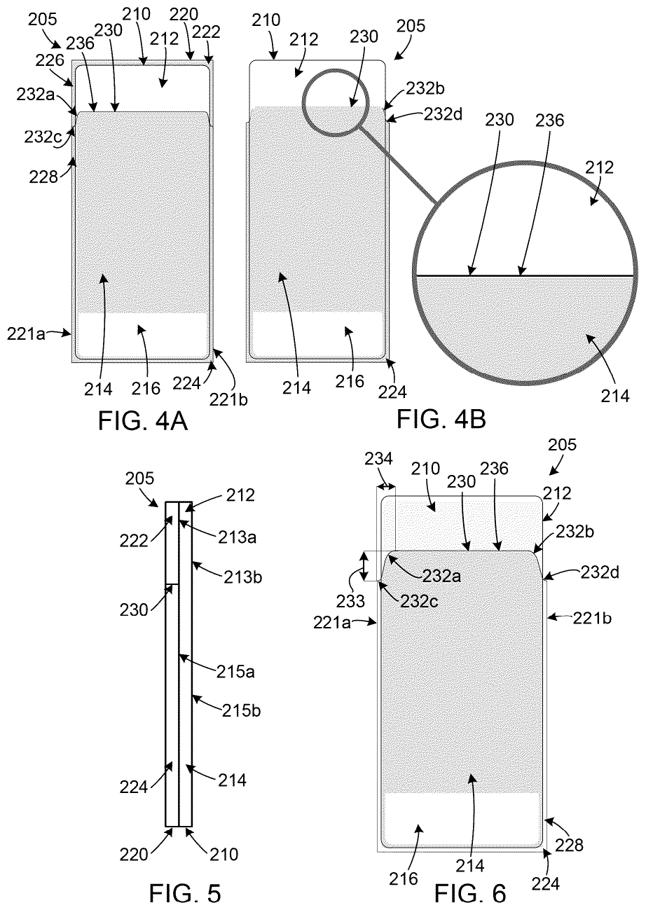

The label assembly 205 includes a liner 220 (e.g., base, etc.). In FIGS. 3 and 4A, the liner 220 has a shape that is a rectangle. In other embodiments, the liner 220 may have a shape that is a square, a polygon, a rounded rectangle, a rounded square, a rounded polygon, or other geometric shape. The liner 220 has a first edge 221a of the liner 220 that is opposite a second edge 221b of the liner 220.

The liner 220 may be made of plastic, paper, or other suitable materials.

The liner 220 has a liner first portion 222 (e.g., tab, etc.) that is coupled to the label first portion 212. As shown in FIG. 5, the liner first portion 222 is coupled to the adhesive surface 213a of the label first portion 212. The liner first portion 222 is configured to be separable from the label first portion 212. The liner 220 has a liner second portion 224 that is coupled to the label second portion 214. As shown in FIG. 5, the liner second portion 224 is coupled to the adhesive surface 215a of the label second portion 214.

As shown in FIGS. 3, 4A, 4B, and 6, the liner second portion 224 is larger than the liner first portion 222. In other embodiments, the liner second portion 224 may be smaller than the liner first portion 222. In other embodiments, the liner second portion 224 and the liner first portion 222 may have the same size.

As shown in FIG. 4A, a part 226 of the liner first portion 222 is located outward of the label 210 in the top view of the label sheet 200. In other embodiments, the liner first portion 222 may not include the part 226 of the liner first portion 222 such that no part of the liner first portion 222 is located outward of the label 210. As shown in FIG. 4A, the part 226 of the liner first portion 222 is present on and continuous over three sides of the liner first portion 222. In other embodiments, the part 226 of the liner first portion 222 may be present on one or two sides of the liner first portion 222. In other embodiments, the part 226 of the liner first portion 222 may be discontinuous.

As shown in FIGS. 4A, 4B, and 6, a part 228 of the liner second portion 224 is located outward of the label 210 in a top view of the label sheet 200. In other embodiments, the liner second portion 224 may not include the part 228 of the liner second portion 224 such that no part of the liner second portion 224 is located outward of the label 210. As shown in FIG. 4A, the part 228 of the liner second portion 224 is present on and continuous over three sides of the liner second portion 224. In other embodiments, the part 228 of the liner second portion 224 may be present on one or two sides of the liner second portion 224. In other embodiments, the part 228 of the liner second portion 224 may be discontinuous.

As shown in FIG. 3, the part 226 of the liner first portion 222 and the part 228 of the liner second portion 224 together form an area of the label sheet 200 that is located outward of any label 210 and that is positioned at least partially in between a first label 210 of a first one of the plurality of label assemblies 205 and a second label 210 of a second one of the plurality of label assemblies 205.

The label assembly 205 includes a cut 230 (e.g., slit, etc.) formed in the liner 220. The cut 230 is positioned between the liner first portion 222 and the liner second portion 224. The cut 230 may be formed by die cutting or by other suitable means. As shown in FIGS. 3, 4A, 4B, and 6, the cut 230 is positioned closer to one edge of the liner 220 than to an opposite edge of the liner 220. In other embodiments, the cut 230 may be positioned equidistant from the one edge of the liner 220 and the opposite edge of the liner 220. In other embodiments, the cut 230 may be positioned at a different position along a length of the liner 220 as compared to the position of the cut 230 of FIGS. 3, 4A, 4B, and 6.

As shown in FIGS. 3, 4A, 4B, and 6, the cut 230 is continuous. Preferably, the cut 230 is continuous such that the liner 220 has no ties like the ties 129 of the known label assembly 105 that interrupt the cut 230. In other embodiments, the liner 220 may have a minimal number (e.g., one, two, three, etc.) of ties like the ties 129 of the known label assembly 105 that interrupt the cut 230.

The cut 230 includes a first curved portion 232a positioned at the first edge 221a of the liner 220 and a second curved portion 232b positioned at the second edge 221b of the liner 220. As shown in FIGS. 3, 4A, 4B, and 6, the first curved portion 232a and the second curved portion 232b of the cut 230 are positioned at a same length on the first edge 221a and the second edge 221b of the liner 220 respectively. In other embodiments, the first curved portion 232a and the second curved portion 232b of the cut 230 may be positioned at different lengths on the first edge 221a and the second edge 221b of the liner 220 respectively.

As shown in FIGS. 3, 4A, 4B, and 6, at least one of the first curved portion 232a of the cut 230 and the second curved portion 232b of the cut 230 has a shape of at least part of a sigmoid curve. In other embodiments, at least one of the first curved portion 232a of the cut 230 and the second curved portion 232b of the cut 230 may have a shape that is another curve or other geometric shape. As shown in FIGS. 3, 4A, 4B, and 6, the first curved portion 232a and the second curved portion 232b of the cut 230 have the same shape. In other embodiments, the first curved portion 232a and the second curved portion 232b of the cut 230 may have different shapes. As shown in FIGS. 3, 4A, 4B, and 6, the first curved portion 232a and the second curved portion 232b of the cut 230 are positioned such that the first curved portion 232a and the second curved portion 232b of the cut 230 both extend towards a center of the label assembly 205. In other embodiments, at least one of the first curved portion 232a and the second curved portion 232b of the cut 230 may extend away from the center of the label assembly 205.

As shown in FIG. 3, the first curved portion 232a of the cut 230 of a first one of the plurality of label assemblies 205 and the second curved portion 232b of the cut 230 of a second one of the plurality of label assemblies 205 form a wave 231 and together have a shape of at least part of a sine wave.

As shown in FIGS. 3, 4A, 4B, and 6, the cut 230 includes a connecting portion 236 extending from the first curved portion 232a to the second curved portion 232b of the cut 230, the connecting portion 236 being straight. In other embodiments, the connecting portion 236 of the cut 230 may be curved, have multiple straight segments, or have a combination of curves and multiple straight segments. As shown in FIGS. 3, 4A, 4B, and 6, the connecting portion 236 of the cut 230 is parallel to an edge of label assembly 205. In other embodiments, the connecting portion 236 of the cut 230 may not be parallel to any edge of the label assembly 205.

As shown in FIGS. 3 and 4A, a part 232c of the first curved portion 232a of the cut 230 is located outward of the label 210 in a top view of the label sheet 200, in between the part 226 of the liner first portion 222 and the part 228 of the liner second portion 224. As shown in FIGS. 3 and 4A, a part 232d of the second curved portion 232b of the cut 230 is located outward of the label 210 in a top view of the label sheet 200, in between the part 226 of the liner first portion 222 and the part 228 of the liner second portion 224. As shown in FIG. 3, the part 232c of the first curved portion 232a of the cut 230 and the part 232d of the second curved portion 232b of the cut 230 are the portions of the wave 231 positioned between a first label 210 of a first one of the plurality of label assemblies 205 and a second label 210 of a second one of the plurality of label assemblies 205.

As shown in FIGS. 3, 4A, 4B, and 6, a first dimension 233 of one of the first curved portion 232a of the cut 230 and of the second curved portion 232b of the cut 230 differs from a second dimension 234 of the same first curved portion 232a or second curved portion 232b of the cut 230. In other embodiments, the first dimension 233 of one of the first curved portion 232a of the cut 230 and of the second curved portion 232b of the cut 230 is the same as the second dimension 234 of the same first curved portion 232a or second curved portion 232b of the cut 230.

As shown in FIGS. 3, 4A, 4B, and 6, the first dimension 233 and the second dimension 234 of the first curved portion 232a of the cut 230 are the same as the first dimension 233 and the second dimension 234 of the second curved portion 232b of the cut 230. In other embodiments, at least one of the first dimension 233 and the second dimension 234 of the first curved portion 232a of the cut 230 is different from at least one of the first dimension 233 and the second dimension 234 of the second curved portion 232b of the cut 230.

In one embodiment, the first dimension 233 of the first curved portion 232a of the cut 230 is approximately in a range of 0.15 to 0.40 inches and the second dimension 234 of the first curved portion 232a of the cut 230 perpendicular to the first dimension 233 is approximately in a range of 0.10 to 0.25 inches. In another embodiment, the first dimension 233 of the first curved portion 232a of the cut 230 is approximately in a range of 0.20 to 0.35 inches and the second dimension 234 of the first curved portion 232a of the cut 230 perpendicular to the first dimension 233 is approximately in a range of 0.125 to 0.20 inches.

For example, in one embodiment the first dimension 233 of the first curved portion 232a of the cut 230 is 0.35 inches and the second dimension 234 of the first curved portion 232a of the cut 230 is 0.20 inches. In another embodiment, the first dimension 233 of the first curved portion of the cut 230 is 0.25 inches. In another embodiment, the first dimension 233 of the first curved portion of the cut 230 is 0.20 inches and the second dimension 234 of the first curved portion 232a of the cut 230 is 0.125 inches.

### Methods of Manufacturing Label Sheets Containing Label Assemblies and Label Assemblies

A first method of manufacturing a label sheet 200 includes providing a plurality of label assemblies 205, each label assembly 205 including a label 210 and a liner 220. The first method also includes forming a cut 230 in each liner 220. In some embodiments, the first method further includes printing on a second surface 213b or 215b opposite an adhesive surface 213a or 213b of at least one of a label first portion 212 and a label second portion 214. In some embodiments, the step of printing comprises laser printing. In some embodiments, the step of forming the cut 230 is performed by die cutting. In some embodiments, the label sheet 200 is a first label sheet 200 coupled to a second label sheet 200, and the first method includes folding the first label sheet 200 such that the first label sheet 200 contacts the second label sheet 200. In some embodiments, the label sheet 200 also includes a first row of pin-feeding holes 203 at a first edge 201 of the label sheet 200 and a second row of pin-feeding holes 204 at a second edge 202 of the label sheet 200, and the method further includes pin-feeding the label sheet 200 to a printer using the first and second rows of pin-feeding holes 203 and 204. In some embodiments, the method further includes separating at least some of the plurality of label assemblies 205 from the label sheet 200 using a cutter-stacker.

The first method includes providing a plurality of label assemblies 205, each label assembly 205 including a label 210 and a liner 220. The label 210 includes a label first portion 212 having an adhesive surface 213a, and a label second portion 214 having an adhesive surface 215a. The liner 220 includes a liner first portion 222 coupled to the adhesive surface 213a of the label first portion 212, and a liner second portion 224 coupled to the adhesive surface 215a of the label second portion 214. While the first method is described with respect to the label sheet 200, label 210, and liner 220, it should be appreciated that the operations of the first method are equally applicable to any other label sheet, label, and liner analogous to those described therein.

The first method also includes forming a cut 230 in each liner 220. The cut 230 is positioned between the liner first portion 222 and the liner second portion 224. The cut 230 includes a first curved portion 232a positioned at a first edge 221a of the liner 220 and a second curved portion 232b positioned at a second edge 221b of the liner 220. The liner first portion 222 is configured to be separable from the label first portion 212.

In some embodiments, the first method also includes printing on a second surface 213b opposite an adhesive surface 213a or on a second surface 215b opposite an adhesive surface 215a of at least one of a label first portion 212 and a label second portion 214 respectively. In some embodiments, the step of printing comprises laser printing.

In some embodiments, the step of forming the cut 230 is performed by die cutting. In other embodiments, the step of forming the cut 230 is accomplished by other suitable means.

In some embodiments, the label sheet 200 is a first label sheet 200 coupled to a second label sheet 200 and the first method includes folding the first label sheet 200 such that the first label sheet 200 contacts the second label sheet 200 (e.g., fan-folding). In some embodiments, the step of folding the label sheet 200 may include folding that occurs when the label sheet 200 passes through a press or a printer among other suitable components of a manufacturing process or a printing process.

In some embodiments, the method also includes pin-feeding the label sheet 200 to a printer using a first row and second row of pin-feeding holes 203 and 204. The label sheet 200 may include the first row of pin-feeding holes 203 at a first edge 201 of the label sheet 200 and the second row of pin-feeding holes 204 at a second edge 202 of the label sheet 200.

In some embodiments, the method also includes separating at least some of the plurality of label assemblies 205 from the label sheet 200 using a cutter-stacker, which cuts at least some of the plurality of label assemblies 205 from the label sheet 200 and arranges at least some of the plurality of label assemblies 205 into a stack. In other embodiments, the method includes separating at least some of the plurality of label assemblies 205 from the label sheet 200 using a manual operation, machine, tool, or other suitable means.

A second method of manufacturing a label assembly 205 includes providing a liner 220 and a label 210. The second method also includes forming a cut 230 in the liner 220. In some embodiments, the second method also includes printing on a second surface 213b or 215b opposite the adhesive surface 213a or 213b of at least one of a label first portion 212 and a label second portion 214. In some embodiments, the step of printing comprises laser printing. In some embodiments, the step of forming the cut 230 is performed by die cutting.

The second method includes providing a liner 220 and a label 210. The label 210 includes a label first portion 212 having an adhesive surface 213a, and a label second portion 214 having an adhesive surface 215a. The liner 220 includes a liner first portion 222 coupled to the adhesive surface 213a of the label first portion 212, and a liner second portion 224 coupled to the adhesive surface 215a of the label second portion 214. While the second method is described with respect to the label sheet 200, label 210, and liner 220, it should be appreciated that the operations of the second method are equally applicable to any other label sheet, label, and liner analogous to those described therein.

The second method also includes forming a cut 230 in the liner 220. The cut 230 is positioned between the liner first portion 222 and the liner second portion 224. The cut 230 includes a first curved portion 232a positioned at a first edge 221a of the liner 220 and a second curved portion 232b positioned at a second edge 221b of the liner 220. The liner first portion 222 is configured to be separable from the label first portion 212.

In some embodiments, the second method also includes printing on a second surface 213b opposite an adhesive surface 213a or on a second surface 215b opposite an adhesive surface 215a of at least one of the label first portion 212 and the label second portion 214 respectively. In some embodiments, the step of printing comprises laser printing.

In some embodiments, the step of forming the cut 230 is performed by die cutting. In other embodiments, forming the cut 230 is accomplished by other suitable means.

Construction of Example Embodiments

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Additionally, it should be understood that features from one embodiment disclosed herein may be combined with features of other embodiments disclosed herein as one of ordinary skill in the art would understand. Other substitutions, modifications, changes and omissions may also be made in the design, operating conditions and arrangement of the various exemplary embodiments without departing from the scope of the present invention.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

As utilized herein, the terms “substantially,” “generally,” “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the appended claims.

Also, the term “or” is used, in the context of a list of elements, in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Additionally, the use of ranges of values (e.g., W1 to W2, etc.) herein are inclusive of their maximum values and minimum values (e.g., W1 to W2 includes W1 and includes W2, etc.), unless otherwise indicated. Furthermore, a range of values (e.g., W1 to W2, etc.) does not necessarily require the inclusion of intermediate values within the range of values (e.g., W1 to W2 can include only W1 and W2, etc.), unless otherwise indicated.

1. A label sheet comprising:
a plurality of label assemblies, each label assembly comprising:
a label comprising:
a label first portion having an adhesive surface, and
a label second portion having an adhesive surface; and
a liner comprising:
a liner first portion coupled to the label first portion, the liner first portion configured to be separable from the label first portion,
a liner second portion coupled to the label second portion, and
a cut formed in the liner and positioned between the liner first portion and the liner second portion, the cut comprising a first curved portion positioned at a first edge of the liner and a second curved portion positioned at a second edge of the liner.

2. The label sheet of claim 1, wherein each label assembly is a shelf talker.

3. The label sheet of claim 1, wherein at least one of the label first portion and the label second portion contains printed material on a second surface opposite the adhesive surface.

4. The label sheet of claim 3, wherein the printed material is laser-printed material.

5. The label sheet of claim 1, wherein the cut is continuous.

6. The label sheet of claim 1, the cut further comprising a connecting portion extending from the first curved portion to the second curved portion, the connecting portion being straight.

7. The label sheet of claim 1, wherein at least one of the first curved portion of the cut and the second curved portion of the cut has a shape of at least part of a sigmoid curve.

8. The label sheet of claim 1, wherein a first dimension of one of the first curved portion of the cut and of the second curved portion of the cut differs from a second dimension of the same first curved portion or second curved portion of the cut.

9. The label sheet of claim 1, wherein a first dimension of the first curved portion of the cut is 0.15 to 0.40 inches and a second dimension of the first curved portion of the cut perpendicular to the first dimension is 0.10 to 0.25 inches.

10. The label sheet of claim 1, wherein a first dimension of the first curved portion of the cut is 0.20 to 0.35 inches and a second dimension of the first curved portion of the cut perpendicular to the first dimension is 0.125 to 0.20 inches.

11. The label sheet of claim 1, wherein:
part of the liner first portion is located outward of the label in a top view of the label sheet;
part of the liner second portion is located outward of the label in a top view of the label sheet;
part of the first curved portion is located outward of the label in a top view of the label sheet; and
part of the second curved portion is located outward of the label in a top view of the label sheet.

12. The label sheet of claim 1, wherein the first curved portion of the cut of a first label assembly and the second curved portion of the cut of a second label assembly together have a shape of at least part of a sine wave.

13. The label sheet of claim 1, wherein the label sheet is a first label sheet coupled to a second label sheet, the first label sheet configured to be folded such that the first label sheet contacts the second label sheet.

14. The label sheet of claim 1, further comprising a first row of pin-feeding holes at a first edge of the label sheet and a second row of pin-feeding holes at a second edge of the label sheet.

15. A label assembly comprising:
a label comprising:
a label first portion having an adhesive surface, and
a label second portion having an adhesive surface; and
a liner comprising:
a liner first portion coupled to the label first portion, the liner first portion configured to be separable from the label first portion,
a liner second portion coupled to the label second portion, and
a cut formed in the liner and positioned between the liner first portion and the liner second portion, the cut comprising a first curved portion positioned at a first edge of the liner and a second curved portion positioned at a second edge of the liner.

16. The label assembly of claim 15, wherein the label assembly is a shelf talker.

17. The label assembly of claim 15, wherein the label assembly is part of a label sheet containing a plurality of label assemblies.

18. The label assembly of claim 15, wherein at least one of the label first portion and the label second portion contains printed material on a second surface opposite the adhesive surface.

19. The label assembly of claim 18, wherein the printed material is laser-printed material.

20. The label assembly of claim 15, wherein the cut is continuous.

21. The label assembly of claim 15, the cut further comprising a connecting portion extending from the first curved portion to the second curved portion, the connecting portion being straight.

22. The label assembly of claim 15, wherein at least one of the first curved portion of the cut and the second curved portion of the cut has a shape of at least part of a sigmoid curve.

23. The label assembly of claim 15, wherein a first dimension of the first curved portion of the cut or of the second curved portion of the cut differs from a second dimension of the same first curved portion or second curved portion of the cut.

24. The label assembly of claim 15, wherein a first dimension of the first curved portion of the cut is 0.15 to 0.40 inches and a second dimension of the first curved portion of the cut perpendicular to the first dimension is 0.10 to 0.25 inches.

25. The label assembly of claim 15, wherein a first dimension of the first curved portion of the cut is 0.20 to 0.35 inches and a second dimension of the first curved portion of the cut perpendicular to the first dimension is 0.125 to 0.20 inches.

26. The label assembly of claim 1, wherein:
part of the liner first portion is located outward of the label in a top view of the label assembly;
part of the liner second portion is located outward of the label in a top view of the label assembly;
part of the first curved portion is located outward of the label in a top view of the label assembly; and
part of the second curved portion is located outward of the label in a top view of the label assembly.

27. A method of manufacturing a label sheet, the method comprising:
providing a plurality of label assemblies, each label assembly comprising a label and a liner; wherein
the label comprises a label first portion having an adhesive surface, and a label second portion having an adhesive surface, and
the liner comprises a liner first portion coupled to the label first portion, and a liner second portion coupled to the label second portion; and
forming a cut in each liner, the cut positioned between the liner first portion and the liner second portion, the cut comprising a first curved portion positioned at a first edge of the liner and a second curved portion positioned at a second edge of the liner; wherein:
the liner first portion is configured to be separable from the label first portion.

28.-33. (canceled)

34. A method of manufacturing a label assembly comprising:
providing a liner and a label; wherein:
the label comprises a label first portion having an adhesive surface, and a label second portion having an adhesive surface, and
the liner comprises a liner first portion coupled to the label first portion, and a liner second portion coupled to the label second portion; and
forming a cut in the liner, the cut positioned between the liner first portion and the liner second portion, the cut comprising a first curved portion positioned at a first edge of the liner and a second curved portion positioned at a second edge of the liner; wherein:
the liner first portion is configured to be separable from the label first portion.

35.-37. (canceled)
